(19) United States
(12) Patent Application Publication
(10) Pub. No.: US 2017/0229218 A1
(43) Pub. Date: Aug. 10, 2017

(54) Electric Fence Coupler Assembly

(71) Applicant: Robert Bergsieker, Higginsville, MO (US)

(72) Inventor: Robert Bergsieker, Higginsville, MO (US)

(21) Appl. No.: 15/040,689

(22) Filed: Feb. 10, 2016

(51) Int. Cl. H01B 17/16; H01B 17/14

(52) U.S. Cl. CPC H01B 17/16; H01B 17/145

(57) ABSTRACT

An electric fence coupler assembly includes an insulator that may be removably coupled to a fence post. The insulator may engage an electric fence thereby facilitating the electric fence to be retained on the fence post. The insulator is comprised of a resiliently bendable material. Thus, the insulator frictionally engages the fence post thereby facilitating the insulator to be removably retained on the fence post. A pair of clips is coupled to the insulator and each of the clips engages the electric fence.

### BACKGROUND OF THE DISCLOSURE

### Field of the Disclosure

The disclosure relates to coupler devices and more particularly pertains to a new coupler device for coupling an electric fence to a fence post.

### SUMMARY OF THE DISCLOSURE

An embodiment of the disclosure meets the needs presented above by generally comprising an insulator that may be removably coupled to a fence post. The insulator may engage an electric fence thereby facilitating the electric fence to be retained on the fence post. The insulator is comprised of a resiliently bendable material. Thus, the insulator frictionally engages the fence post thereby facilitating the insulator to be removably retained on the fence post. A pair of clips is coupled to the insulator and each of the clips engages the electric fence.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an electric fence coupler assembly according to an embodiment of the disclosure.

FIG. 2 is a bottom view of an embodiment of the disclosure.

FIG. 3 is a back view of an embodiment of the disclosure.

FIG. 4 is a right side view of an embodiment of the disclosure.

FIG. 5 is a perspective view of an embodiment of the disclosure.

### DESCRIPTION OF THE PREFERRED EMBODIMENT

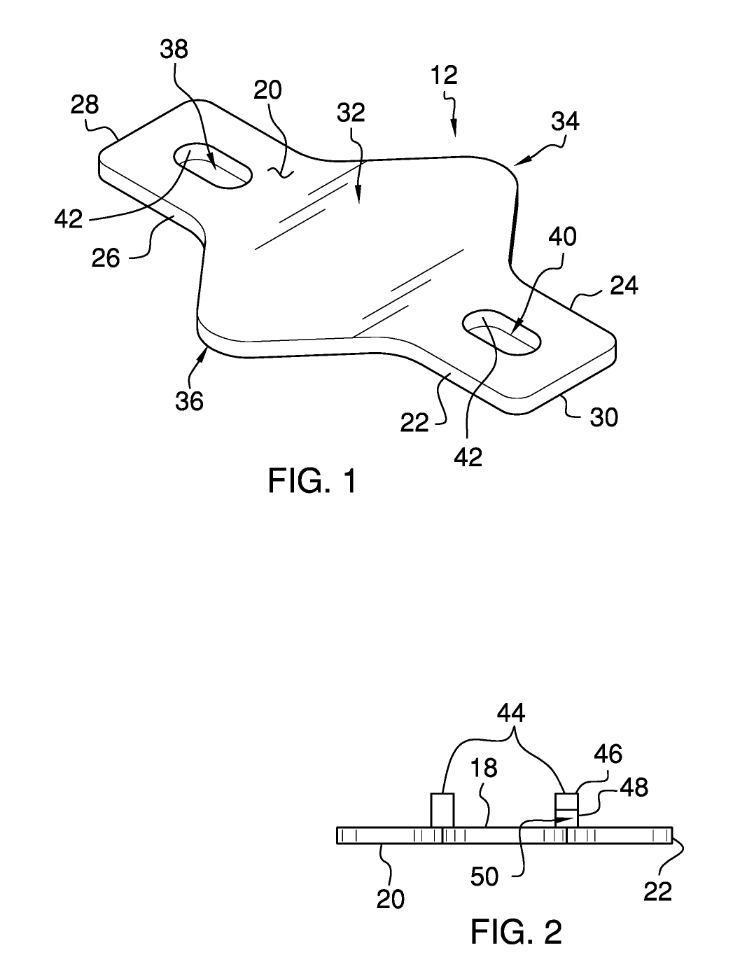

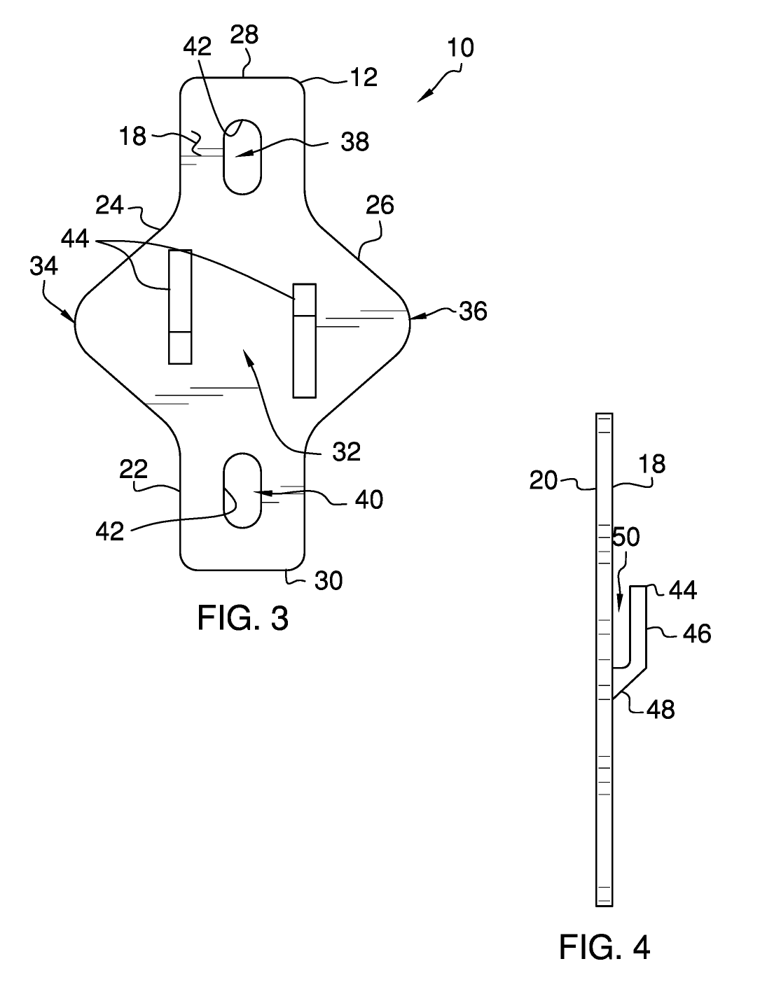

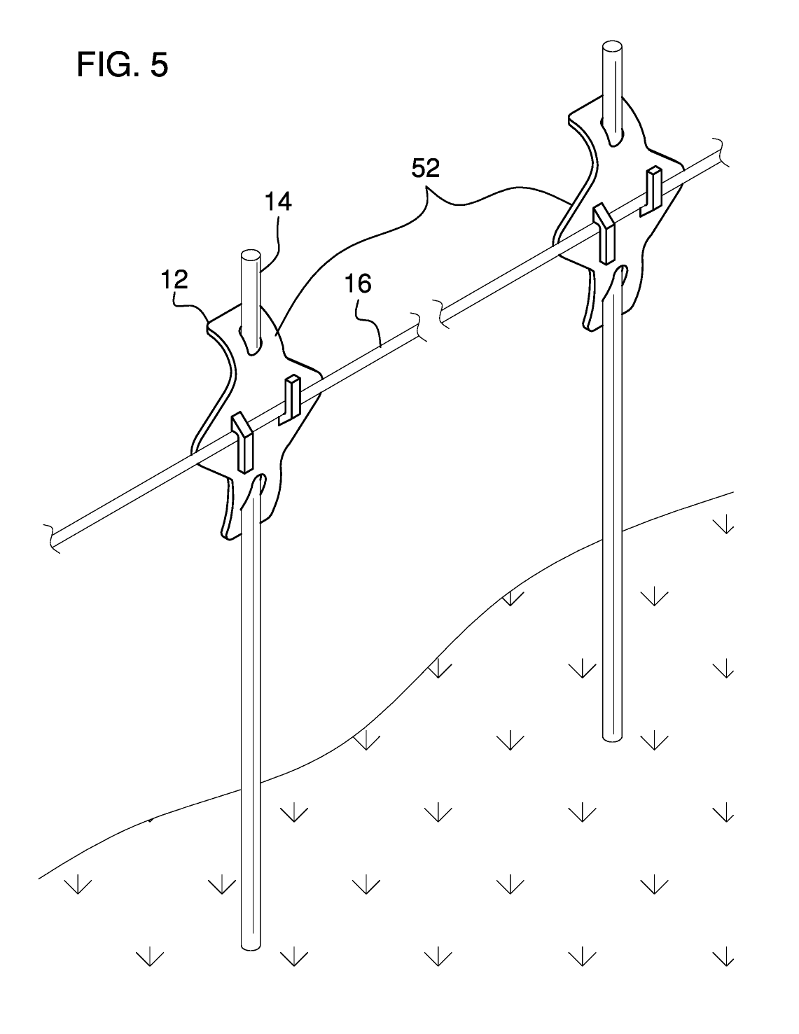

With reference now to the drawings, and in particular to FIGS. 1 through 5 thereof, a new coupler device embodying the principles and concepts of an embodiment of the disclosure and generally designated by the reference numeral 10 will be described.

As best illustrated in FIGS. 1 through 5, the electric fence coupler assembly 10 generally comprises an insulator 12 that may be removably coupled to a fence post 14. The fence post 14 may comprise a metallic rod utilized in the convention of electric fences. The insulator 12 may to engage an electric fence 16 thereby facilitating the electric fence 16 to be retained on the fence post 14. The electric fence 16 may comprise an un-insulated electric conductor or the like. The insulator 12 is comprised of an electrically insulating material. Thus, the fence post 14 is electrically insulated from the electric fence 16.

The insulator 12 has a first surface 18, a second surface 20 and a peripheral edge 22 extending between the first surface 18 and the second surface 20. The peripheral edge 22 has a first lateral side 24, a second lateral side 26, a top side 28 and a bottom side 30. The first lateral side 24 curves outwardly from a center 32 of the insulator 12 to define a first lobe 34. The second lateral side 26 curves outwardly from the center 32 of the insulator 12 to define a second lobe 36.

The insulator 12 has a first slot 38 extending through the first surface 18 and the second surface 20. The first slot 38 is positioned closer to the top side 28 than the bottom side 30. The insulator 12 has a second slot 40 extending through the first surface 18 and the second surface 20. The second slot 40 is positioned closer to the bottom side 30 than the top side 28. Each of the first slot 38 and the second slot 40 are positioned on a bisecting longitudinal axis of the insulator 12.

The insulator 12 is comprised of a resiliently bendable material. Thus, the insulator 12 is bendable having each of the top side 28 and the bottom side 30 being urged toward each other. The first slot 38 is aligned with the second slot 40 when the insulator 12 is bent. Thus, each of the first slot 38 and the second slot 40 may have the fence post 14 extended therethrough.

Each of the first slot 38 and the second slot 40 has a bounding edge 42. The insulator 12 is biased into a flattened position. The bounding edge 42 of each of the first slot 38 and the second slot 40 frictionally engages the fence post 14. Thus, the insulator 12 is removably retained on the fence post 14.

A pair of clips 44 is provided. Each of the clips 44 is coupled to the insulator 12 and each of the clips 44 engages the electric fence 16. Each of the clips 44 comprises a leg 46 and a foot 48. The foot 48 of each of the clips 44 is coupled to the first surface 18 of the insulator 12. The leg 46 of each of the clips 44 is spaced from the first surface 18 to define a space 50 between the clips 44 and the insulator 12.

Each of the clips 44 is spaced apart from the center 32 of the insulator 12. The leg 46 corresponding to one of the clips 44 is directed toward the top side 28. The leg 46 corresponding to one of the clips 44 is directed toward the bottom side 30. One of the clips 44 is positioned closer to the top side 28 than the bottom side 30. One of the clips 44 is positioned closer to the bottom side 30 than the top side 28.

The space 50 corresponding to each of the clips 44 may have the electric fence 16 positioned therein. Thus, the electric fence 16 is removably coupled to the insulator 12. The electric fence 16 rests on each of the first lobe 34 and the second lobe 36 when the electric fence 16 is removably coupled to the insulator 12. Thus, the insulator 12 orients the electric fence 16 perpendicular to the fence post 14. The insulator 12 is one of a plurality of insulators 52. Each of the plurality of insulators 52 is positioned on an associated one of a plurality of fence posts 14.

In use, the insulator 12 is bent to align the first slot 38 with the second slot 40. The fence post 14 is inserted through each of the first slot 38 and the second slot 40. The insulator 12 is released when the fence post 14 is inserted through each of the first slot 38 and the second slot 40. Thus, the bounding edge 42 corresponding to each of the first slot 38 and the second slot 40 frictionally engages the fence post 14. The electric fence 16 is positioned in the space 50 corresponding to each of the clips 44. The above described process is repeated on each of the plurality of insulators 52.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electric fence coupler assembly comprising:
an insulator being configured to be removably coupled to a fence post, said insulator being configured to engage an electric fence thereby facilitating the electric fence to be retained on the fence post, said insulator being comprised of a resiliently bendable material wherein said insulator is configured to frictionally engage the fence post thereby facilitating said insulator to be removably retained on the fence post; and
a pair of clips, each of said clips being coupled to said insulator wherein each of said clips is configured to engage the electric fence.

2. The assembly according to claim 1, wherein said insulator has a first surface, a second surface and a peripheral edge extending between said first surface and said second surface, said peripheral edge having a first lateral side, a second lateral side, a top side and a bottom side, each of said first lateral side and said second lateral side curving outwardly from a center of said insulator.

3. The assembly according to claim 2, wherein:
said insulator has a first slot extending through said first surface and said second surface, said first slot being positioned closer to said top side than said bottom side; and
said insulator has a second slot extending through said first surface and said second surface, said second slot being positioned closer to said bottom side than said top side.

4. The assembly according to claim 3, wherein said insulator is bendable having each of said top side and said bottom side being urgeable toward each other such that said first slot is aligned with said second slot wherein each of said first slot and said second slot are configured to have the fence post extended therethrough.

5. The assembly according to claim 3, wherein each of said first slot and said second slot has a bounding edge, said insulator being biased into a flattened position such that said bounding edge of each of said first slot and said second slot frictionally engages the fence post.

6. The assembly according to claim 2, wherein each of said clips comprises a leg and a foot, said foot of each of said clips being coupled to said first surface of said insulator, said leg of each of said clips being spaced from said first surface to define a space between said clips and said insulator, each of said clips being spaced apart from said center of said insulator.

7. The assembly according to claim 6, wherein said leg corresponding to one of said clips being directed toward said top side, said leg corresponding to one of said clips being directed toward said bottom side.

8. The assembly according to claim x, wherein one of said clips is positioned closer to said top side than said bottom side, one of said clips being positioned closer to said bottom side than said top side, said space corresponding to each of said clips being configured to have the electric fence being positioned therein thereby facilitating the electric fence to be removably coupled to said insulator.

9. An electric fence coupler assembly comprising:
an insulator being configured to be removably coupled to a fence post, said insulator being configured to engage an electric fence thereby facilitating the electric fence to be retained on the fence post, said insulator being comprised of a resiliently bendable material wherein said insulator is configured to frictionally engage the fence post thereby facilitating said insulator to be removably retained on the fence post, said insulator having a first surface, a second surface and a peripheral edge extending between said first surface and said second surface, said peripheral edge having a first lateral side, a second lateral side, a top side and a bottom side, each of said first lateral side and said second lateral side curving outwardly from a center of said insulator, said insulator having a first slot extending through said first surface and said second surface, said first slot being positioned closer to said top side than said bottom side, said insulator having a second slot extending through said first surface and said second surface, said second slot being positioned closer to said bottom side than said top side, said insulator being bendable having each of said top side and said bottom side being urgeable toward each other such that said first slot is aligned with said second slot wherein each of said first slot and said second slot are configured to have the fence post extended therethrough, each of said first slot and said second slot having a bounding edge, said insulator being biased into a flattened position such that said bounding edge of each of said first slot and said second slot frictionally engages the fence post; and
a pair of clips, each of said clips being coupled to said insulator wherein each of said clips is configured to engage the electric fence, each of said clips comprising a leg and a foot, said foot of each of said clips being coupled to said first surface of said insulator, said leg of each of said clips being spaced from said first surface to define a space between said clips and said insulator, each of said clips being spaced apart from said center of said insulator, said leg corresponding to one of said clips being directed toward said top side, said leg corresponding to one of said clips being directed toward said bottom side, one of said clips being positioned closer to said top side than said bottom side, one of said clips being positioned closer to said bottom side than said top side, said space corresponding to each of said clips being configured to have the electric fence being positioned therein thereby facilitating the electric fence to be removably coupled to said insulator.
